(19) United States
(12) Patent Application Publication
(10) Pub. No.: US 2024/0343290 A1
(43) Pub. Date: Oct. 17, 2024

(54) UTILITY CART WIHT A HANDLE ADAPTABLE FOR PULLING AND PUSHING

(71) Applicants: Michael E Miller, Waukesha, WI (US); Djan Nikolic, Franklin, WI (US)

(72) Inventors: Michael E Miller, Waukesha, WI (US); Djan Nikolic, Franklin, WI (US)

(21) Appl. No.: 18/425,441

(22) Filed: Jan. 29, 2024

Related U.S. Application Data
(60) Provisional application No. 63/441,669, filed on Jan. 27, 2023.

(51) Int. Cl. B62B 5/06; B62B 3/00

(52) U.S. Cl. CPC B62B 5/06; B62B 3/00

(57) ABSTRACT

A utility cart with a handle that pivots at the base and can be locked in its upright position such that the utility cart is easy to push and unlocked such that the utility cart can be pulled in a conventional way.

### FIELD OF THE INVENTION

The disclosed invention relates to utility carts and the like. More specifically, the claimed invention relates to a utility cart with a handle that pivots at the base and can be locked in its upright position such that the utility cart is easy to push and unlocked such that the utility cart can be pulled in a conventional way.

### BACKGROUND OF THE INVENTION

Conventional utility carts typically provide a fixed handle such that a user can pull the cart along more comfortably using the handle. Alternatively, the utility cart could include an adjustable handle that is generally waist height or higher on a human being that is used to push the utility cart. Carts which only provide a handle for pulling or for pushing are frequently inconvenient and cumbersome to use when the other action is required.

### SUMMARY OF THE INVENTION

The disclosed invention provides a utility cart with a pivoting handle which can be used in a first upright position wherein it is locked in place as a handle for pushing the utility cart. The handle can be unlocked and pivoted to a position where it can be used for pulling the utility cart. An additional feature of the disclosed invention is that when the utility cart is pulled into place, the handle can be locked in its upright position such that it does not present an obstacle or inconvenience to movement around the utility cart.

### BRIEF DESCRIPTION OF THE DRAWINGS

FIG. 1 is a top, front and side perspective view of the utility cart.

FIG. 2 is a top, end and side perspective view of the utility cart showing the handle approaching the upright and locked position with the cam love against the flange of the shelf.

FIG. 3 is a top, end and side perspective view of the utility cart showing the locking mechanism for the handle about to latch over the flange of the shelf.

FIG. 4 is a top, end and side perspective view of the cart showing the handle in the upright position, but not in the locked position.

FIG. 5 is a top, end and side perspective view of the cart showing the handle in the upright position, but not in the locked position.

FIG. 6 is a top, end and side perspective view of the locking mechanism.

FIG. 7 is a top, end and side partially exploded perspective view of the locking mechanism.

FIG. 8 is an exploded view of the locking mechanism.

### DETAILED DESCRIPTION OF THE INVENTION

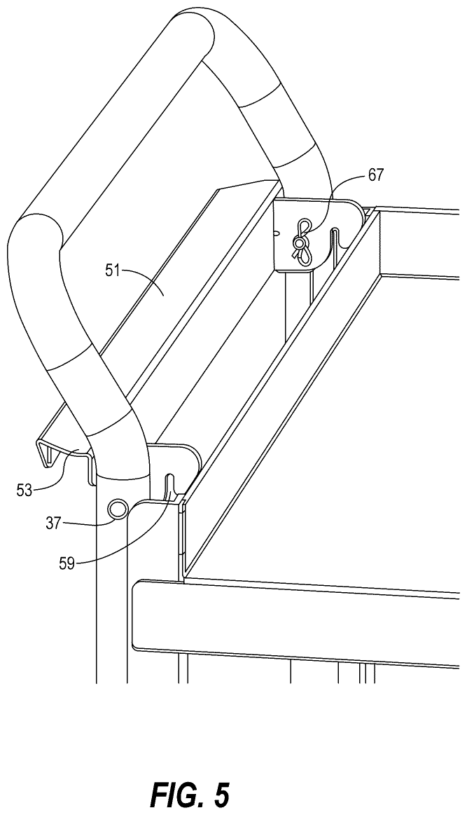

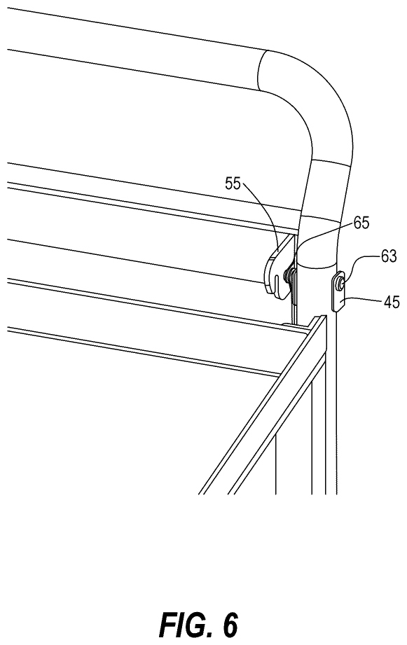

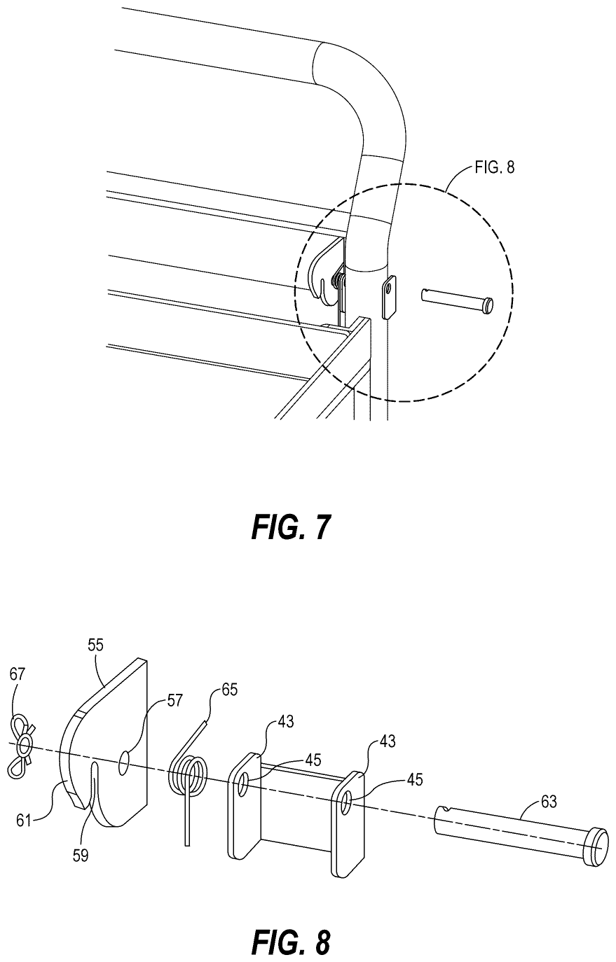

Now referring to the drawings in detail, wherein like reference numerals refer to like elements throughout, FIG. 5 shows an embodiment of the inventive utility cart 1. Utility cart 1 may be nearly any length, width or height. The inventive concept herein is not limited by the size of the utility cart in any dimension.

Utility cart 1 typically comprises a frame member 11. Frame member 11 typically comprises two generally parallel base frame members 13 attached together by platform member 15 or crossmember 17 or both. Vertical frame members 19 are attached to generally parallel base frame members 13 or are integrally formed with base frame member 13 and are generally perpendicular to the base frame member 13. Platform member 15 may serve as a shelf. Alternatively, a shelf may be attached to the base frame members 13 or the vertical frame members 17.

Utility cart 1 typically comprises rear wheels 21. Typically, the rear wheels 21 of utility cart are fixed to a base frame member 13 or a platform member 15 and are placed as close to the outside of the utility cart 1 as possible to increase stability. Rear wheels 21 are also typically of the directionally fixed type, although there may be advantages to using caster-type rear wheels 21 in certain circumstances.

Utility cart further comprises front wheels 23. Front wheels of utility cart are also preferably located as close to the outside of the utility cart 1 as possible to increase the stability of the utility cart 1. Front wheels are fixed to base frame member 13 or platform member 15. Front wheels 23 are typically caster-type wheels to permit the utility cart 1 to be easily maneuvered using tow handle 31.

Utility cart 1 typically comprises multiple shelves. Cross members 17 between vertical frame members 19 on the front, rear and sides of the utility cart 1 can be used to improve the rigidity of the utility cart 1 and to provide a fixed obstacle to prevent items from sliding off one of the shelves 25 on the utility cart 1. Utility cart 1 includes at least one tow handle attachment member 39, which is a front cross member 17.

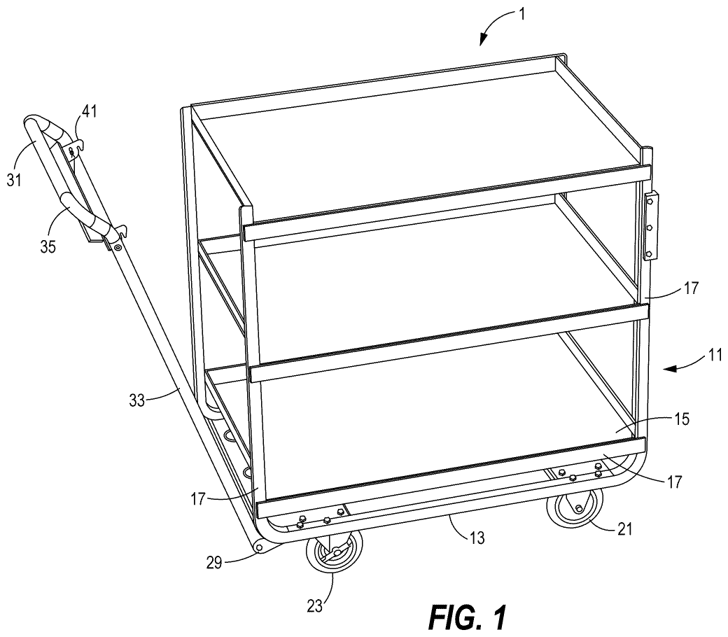

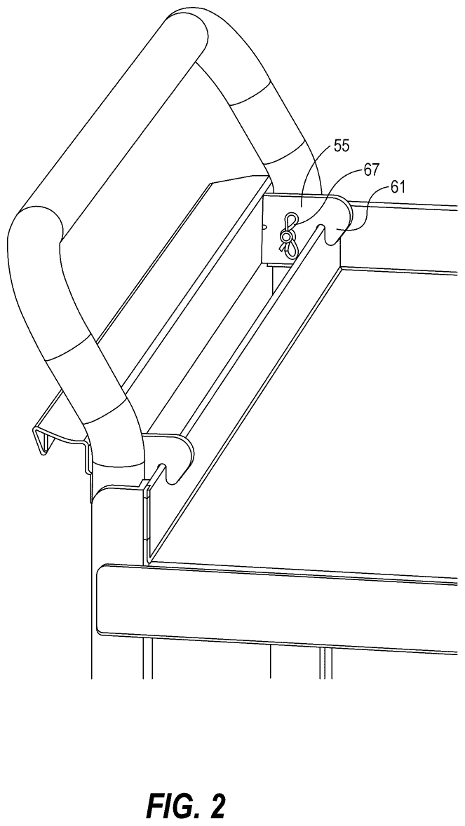

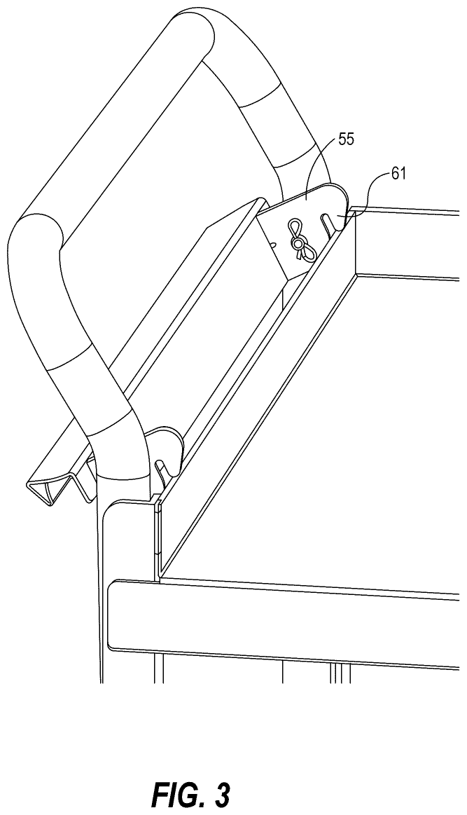

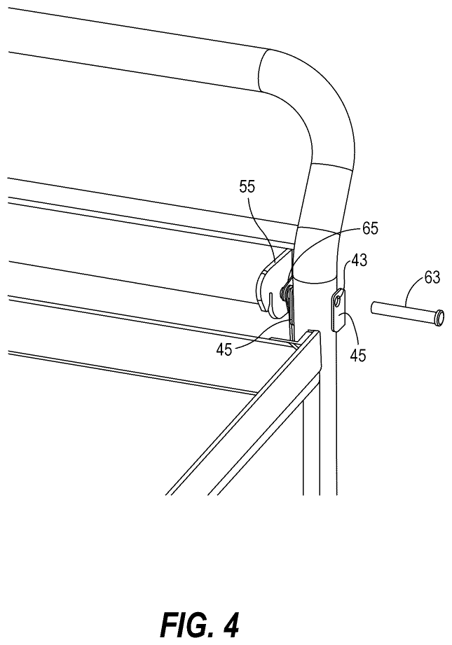

A hinged, longitudinally extending tow handle 31 extends from the front end of utility cart 1. Base frame member 13 or platform member 15 further comprising at least one attachment point for tow handle 31 that permits to tow handle 31 to pivot upwardly and downwardly. In the embodiment shown in FIG. 1, a tow handle bracket 29 is attached to the base frame member 13 of the utility cart 1. Tow handle bracket 29 provides a hinged attachment point for the longitudinally extending tow handle 31 such that tow handle 31 can pivot relative to the utility cart 1.

In the embodiment shown, tow handle 31 of the utility cart 1 comprises an upside-down U-shape with each leg member 33 of the “U” being attached to the tow handle bracket 29. Further, each leg member 33 of the tow handle 31 is connected being connected to the other leg member 33 by grasp handle 35. Tow handle 31 further comprises a tow handle latching subassembly 41.

Tow handle latching subassembly 41 further comprises an aperture 37 in each tow handle leg member, the tow handle leg member apertures 37 being generally aligned with one another. Each tow handle leg member 33 further comprises a U-shaped spring bracket 43. U-shaped spring bracket 43 is sized so as the fit around the tow handle leg member 33 and further comprises an aperture 45.

The tow handle 31 further comprises a torsion bar subassembly 51. Torsion bar subassembly 51 comprises torsion bar 53 which stretches between the tow handle leg members 33 of the tow handle 31. Torsion bar subassembly 51 further comprises at least torsion bar extension member 55 comprising an aperture 57, a hook 59 that extends generally perpendicularly away from the torsion bar 53 and a cam lobe 61 that extends past the hook 59 on torsion bar extension member 55. The torsion bar subassembly 51 further comprises a clevis pin 63. The clevis pin 63 is inserted through the aperture 45 in the U-shaped spring bracket 43, the aperture 37 in the tow handle leg member 33, a torsion spring 65 and the aperture 57 in the torsion bar extension member 55. A cotter pin 67 is used to secure the clevis pin 63 in place and the torsion bar subassembly 55 to the tow handle 31. Torsion spring 65 is used to bias the hook 59 on the torsion bar extension member 55 downwardly.

In operation, in the “up” or push position for the utility cart 1, the tow handle 31 is secured by the hook 59 being latched over the tow handle attachment member 39. Torsion spring 65 biases the hook 59 on torsion bar extension member 55 downwardly to secure the tow handle 31 in the “up” or “push” position. When it is desired or required to pull the utility cart 1, an operator can simply press or twist the torsion bar 53 against the pressure of the torsion spring 65 such that the hook 59 on the torsion bar extension member 55 clears the tow handle attachment member 39. At that point the tow handle 31 can be lowered to the “down” or “pull” position. To re-secure the tow handle 31 in the up or push position, an operator can simply raise the tow handle 31 until the cam lobe 61 on the torsion bar extension member 55 contacts the tow handle attachment member 39 which will cause the torsion bar extension member 55 to be urged upwardly against the torsion spring 65 over the tow handle attachment member 39 where the tow handle 31 can be secured via hook on torsion bar extension member 59.

Although a structure contemplated by the inventors for carrying out the invention is disclosed above, practice of the invention disclosed herein is not limited thereto. It will be manifest that various additions, modifications, and rearrangements of the features of the disclosed invention may be made without deviating from the spirit and scope of the underlying inventive concept.

1. A utility cart comprising:
a frame member having a front and a rear and comprising two generally parallel base frame members attached together using at least one crossmember, the frame member further comprising vertical frame members arising generally perpendicularly from the generally parallel base frame members; the frame member further comprising a tow handle attachment member;
a pair of wheels attached to the rear of the frame member;
a pair of wheels attached to the front of the frame member;
a tow handle bracket attached to the front of the frame member;
a longitudinally extending tow handle attached to the tow handle bracket, the tow handle bracket being operable to pivot relative to the tow handle bracket;
a hook for releasably securing the tow handle to the tow handle attachment member.

2. The utility cart of claim 1 wherein the hook is spring biased downwardly so as to catch on the tow handle attachment member and secure the tow handle.

3. The utility cart of claim 1 wherein the hook is mechanically connected via an extension member to a spring biased torsion bar that biases the hook downwardly so as to catch on the tow handle attachment member and to secure to tow handle.

4. The utility cart of claim 1 wherein the hook is mechanically connected via an extension member to a spring biased torsion bar that biases the hook downwardly so as to catch on the tow handle attachment member to secure the tow handle and wherein the torsion bar can be twisted to as to release the hook so that the town handle can be manipulated.

5. A utility cart comprising:
a frame member having a front and a rear and comprising two generally parallel base frame members attached together using at least one crossmember, the frame member further comprising vertical frame members arising generally perpendicularly from the generally parallel base frame members; the frame member further comprising a tow handle attachment member;
a pair of wheels attached to the rear of the frame member;
a pair of wheels attached to the front of the frame member;
a tow handle bracket attached to the front of the frame member;
a longitudinally extending tow handle attached to the tow handle bracket, the tow handle bracket being operable to pivot relative to the tow handle bracket;
a hook for releasably securing the tow handle to the tow handle attachment member, the hook being mechanically connected via an extension member to a spring biased torsion bar that biases the hook downwardly so as to catch on the tow handle attachment member to secure the tow handle and wherein the torsion bar can be twisted to as to release the hook so that the town handle can be manipulated.
